(19) United States
(12) Patent Application Publication
(10) Pub. No.: US 2010/0190127 A1
(43) Pub. Date: Jul. 29, 2010

(54) ORTHODONTIC AUXILIARY DEVICE HAVING A SWIVEL FOR ADAPTING TO IMPLANTS

(75) Inventors: Pinki Ghantiwala, Walnut, CA (US); Albert Ruiz-Vela, Alta Loma, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/443,982

(22) PCT Filed: Oct. 10, 2007
(86) PCT No.: PCT/US2007/080878

§ 371 Date: Apr. 7, 2010

Related U.S. Application Data
(60) Provisional application No. 60/850,624, filed on Oct. 10, 2006.

(51) Int. Cl. A61C 7/00

(52) U.S. Cl. 433/18

(57) ABSTRACT

The present invention provides for an orthodontic auxiliary device (2) that attaches to a fixture device (32) (such as a temporary implant, a bonding pad, an archwire, or other) for the alignment of a patient's teeth. In one embodiment, the auxiliary device (2) includes a swivel device (12) connecting a tension device (3) to an attachment portion (8), where the attachment portion (8) connects the auxiliary device (2) to the fixture device (32). The swivel device (12) allows at least partial rotation of the attachment portion (8) about a central axis of the tension device (3).

### PRIORITY CLAIM

This application claims the benefit of U.S. Provisional Patent Application Ser. No. 60/850,624, filed Oct. 10, 2006 and entitled “Orthodontic Devices, Implants and Related Apparatus,” the disclosures of which are expressly incorporated by reference herein in their entirety.

### TECHNICAL FIELD

This invention generally relates to orthodontic systems and, more particularly, to an auxiliary device having a swivel portion, used with a temporary implant, for adapting to a wider range of vector forces.

### BACKGROUND

Orthodontic systems address a wide range of problems in a patient's mouth, such as malocclusion, dentition, and inclination. These systems may be complex and involve the cooperation of several components, including implants, brackets, archwires, and auxiliary devices. The coupling of these devices, in the proper manner, allows the orthodontist to apply the correct vector forces to the teeth to achieve proper alignment. As such, the vector forces would provide the torque and angle necessary to properly align the patient's teeth. Traditionally, the auxilliary devices are attached to the archwires. Thus, the vector forces applied by the auxiliaries, when attached to an archwire or bracket, were basic and predictable.

With the growing frequency of use of auxiliary devices, and in particular in light of the development of temporary implant devices to permit greater positioning versatility within the patient's mouth, the number and complexity of the vector forces applied by the auxiliary devices is no longer simple nor predictable. The complexity of the vector forces is further enhanced by the relative immobility and adaptability of the auxiliary devices. That is, the auxiliaries originally developed for use with archwires alone and available today are unable to adapt to accommodate the new angles and resultant vector forces.

Consequently, when these auxiliaries are loaded, or activated, and used in conjunction with a temporary implant device not placed in a location traditionally reserved for archwires, the result is the unpredicted, and/or at worse, the undesired movement of teeth.

### SUMMARY

The present invention provides for an orthodontic auxiliary device that attaches to a fixture device (such as a temporary implant, a bonding pad, an archwire, or other) for the alignment of a patient's teeth. In one embodiment, the auxiliary device includes a swivel device connecting a tension device to an attachment portion, where the attachment portion connects the auxiliary device to the fixture device. The swivel device allows at least partial rotation of the attachment portion about a central axis of the tension device.

In another embodiment of the present invention, the orthodontic auxiliary device attaches to a fixture device and includes a lock feature. A swivel device attaches an attachment portion to the tension device where the swivel device allows at least partial rotation of the attachment portion about a central axis of the tension device. The attachment portion further comprises a locking-shape. The fixture device provides a locking-shape screwhead such that it may receive the attachment portion having the locking-shape. One of either the attachment portion or the locking-shape screwhead is moveable in a manner such that the position between the attachment portion and the fixture device is secured.

One embodiment of the present invention is for the use of an auxiliary device having at least one swivel device connecting an attachment portion to a tension device consistent with the embodiment herein. The orthodontist rotates the attachment portion about the central axis of the tension device until it is positioned to be received by a fixture device. Finally, the orthodontist places the attachment portion onto the fixture device.

Other embodiments and features of the present invention will become apparent and will be known within the art.

### BRIEF DESCRIPTION OF THE DRAWINGS

Various additional features and aspects of the invention will become readily apparent to persons having ordinary skill in the art from the following description of illustrative embodiments of the invention and from the drawings in which:

FIG. 1 illustrates an eyelet auxiliary device according to the teachings of the prior art.

FIGS. 2 and 2A illustrate the adaptability of one auxiliary device according to the present invention.

FIGS. 3A and 3B illustrate an alternative embodiment of an auxiliary device according to the present invention.

FIGS. 4A, 4B, and 4C illustrate an alternative embodiment of an auxiliary device according to the present invention within the environment of a temporary implant.

FIGS. 5A and 5B illustrate an alternative embodiment of an auxiliary device according to the present invention including a locking feature.

FIG. 6 illustrates an auxiliary device of the present invention in use in the oral environment in combination with an orthodontic implant and a crimpable post.

FIGS. 7A and 7B illustrate a crimpable post in combination with an eyelet.

### DETAILED DESCRIPTION

The present invention will be described in connection with certain several illustrative embodiments but is not limited to practice of any one specific auxiliary device. The description of these embodiments is not intended to cover all alternatives, modifications, and equivalent arrangements as may be included within the spirit and scope of the invention. Those skilled in the art will recognize that the components of the embodiments of the invention described herein could be configured in multiple different ways.

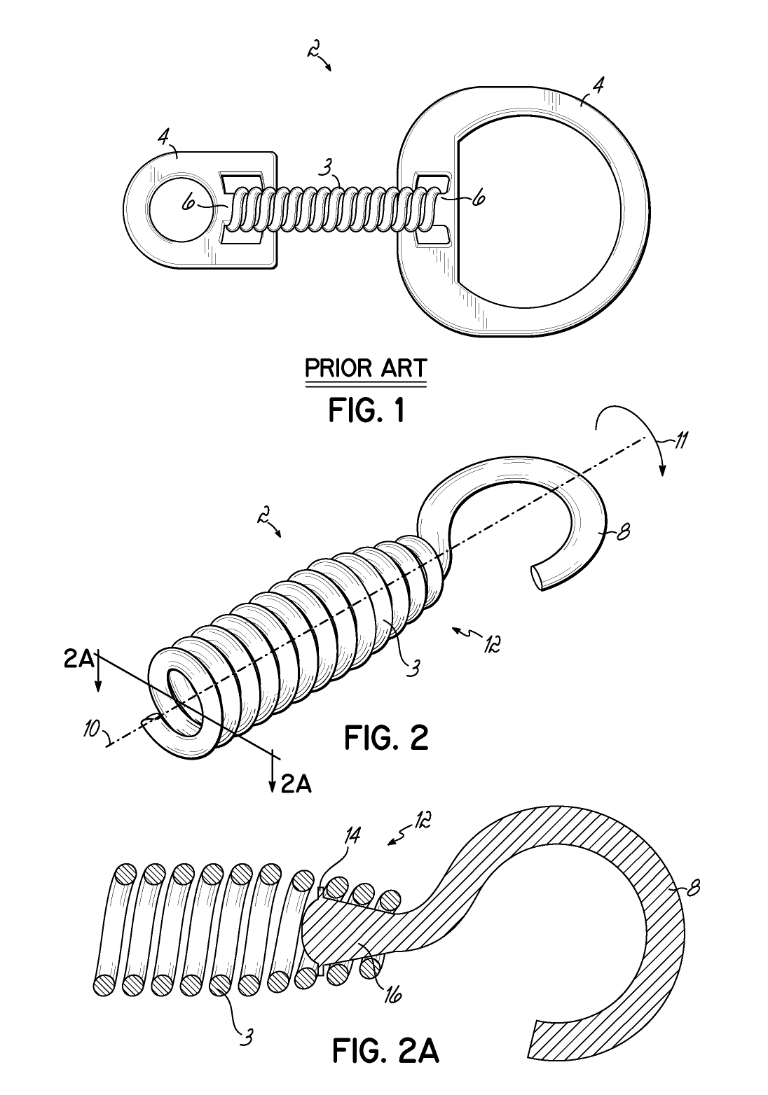

As a point of reference, FIG. 1 illustrates a prior art auxiliary device 2 having an eyelet 4 on each end of a tension device 3, illustrated as a spring. Each eyelet 4 has a fixed attachment point 6 at each respective end of the tension device 3. This fixed attachment point 6 permits only a limited degree of motion between the eyelet 4 and tension device 3. As such, once the orthodontist attaches one eyelet 4 to an archwire (not shown) or temporary insert (not shown), the eyelet 4 at the opposing end of the auxiliary device 2 is limited in possible points of attachment so as to avoid twisting or torquring the spring 3.

Referring now to FIG. 2, the present invention includes a swivel device 12, connecting a tension device 3 (i.e., coil, wire, springs, etc.) and an attachment portion 8 (i.e., eyelet, hook, etc.) wherein the swivel device 16 enables rotation of the attachment portion 8 and increases the number of possible points of attachment. This swivel device 12, as will be explained in greater detail below, permits the orthodontist to properly select the desired vector force and dissipate any unwanted forces associated with the activation of the tension device 3, such as the winding/unwinding force of a coil spring. The swivel device 12 further provides an increase in the number of points of attachment because of the ability to rotate by the attachment portion 8. Thus, the vector forces are once again predictable and proper adjustment of the teeth is possible, even with temporary implants.

Continuing with FIG. 2, the first embodiment includes an attachment portion 8 (shown as a hook) connected to a tension device 3 (spring) with a swivel device 12. As shown, the swivel device 12 allows at least a near full rotation 11 of the attachment portion 8 about a central axis 10 meaning that the illustrated hook is adaptable to a plurality of potential attachment points as compared to the prior art of FIG. 1. In a cross-section viewpoint through central axis 10, FIG. 2A provides additional detail to this particular embodiment. This embodiment demonstrates the swivel device 12 as a rim 14 around the circumference of a ball-joint 16, wherein the rim 14 fits interstitially between adjacent coils of the spring version of a tension device 3. Rim 14 around the circumference of ball-joint 16 provides the desired freedom of rotation 11 while maintaining the connectivity between the attachment portion 8 and tension device 3 comprising the auxiliary device 2.

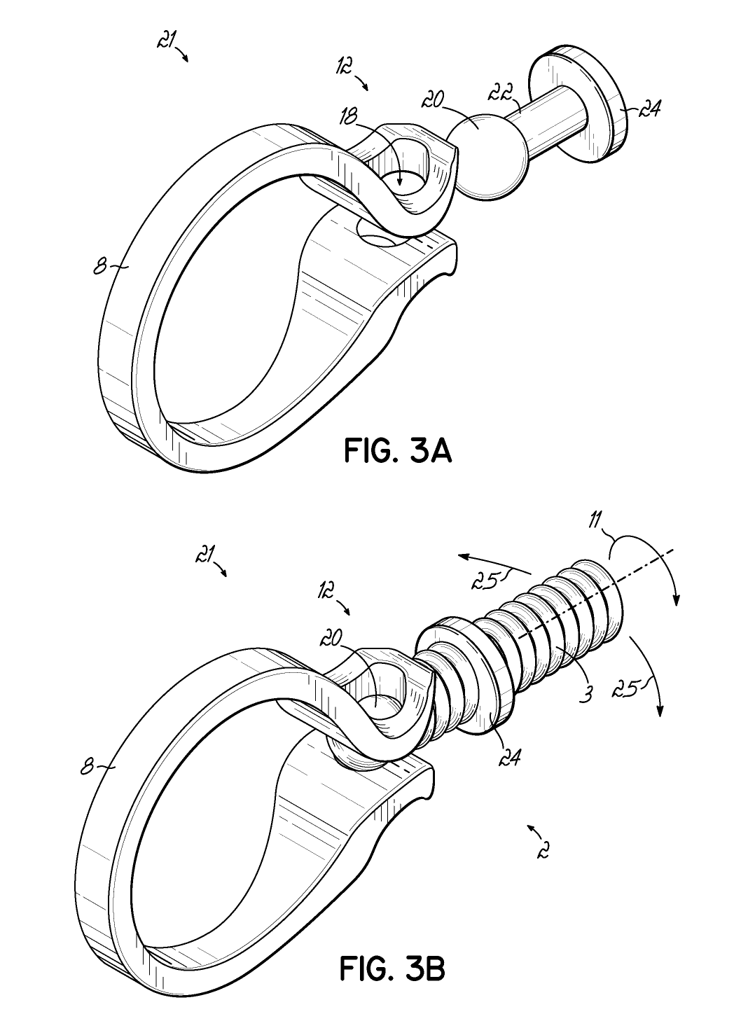

With reference to FIG. 3A, there is shown another embodiment of the present invention. Generally, this embodiment of swivel device 12 includes an attachment portion 8 (specially shown as an eyelet, but could also be a hook or other structure known within the art) having a socket 18, which connects to a tension device 3 via a separate ball-joint 20. Acting together, the attachment portion 8 with the socket 18 and the separate ball joint 20 form a traditional ball-and-socket joint as the swivel device 12. As exemplified, the separate ball-joint 20 includes a shaft 22 and a rim 24, which enable the particular swivel device 12 to be adapted to the tension device 3 (shown as a unit in FIG. 3B) again fitting interstitially between adjacent coils of the tension device 3. Likewise, the ball-and-socket style swivel device 12 provides the desired freedom of rotation 11 described previously. It should also be noted that there are other configurations having similar connectivity and rotation, such as a rim 14 shown previously.

It should further be appreciated that the ball-and-socket style swivel device 12 shown in FIGS. 3A and B not only provides rotation 11 described above, but also a flexing of the joint in a radial direction 25 as shown.

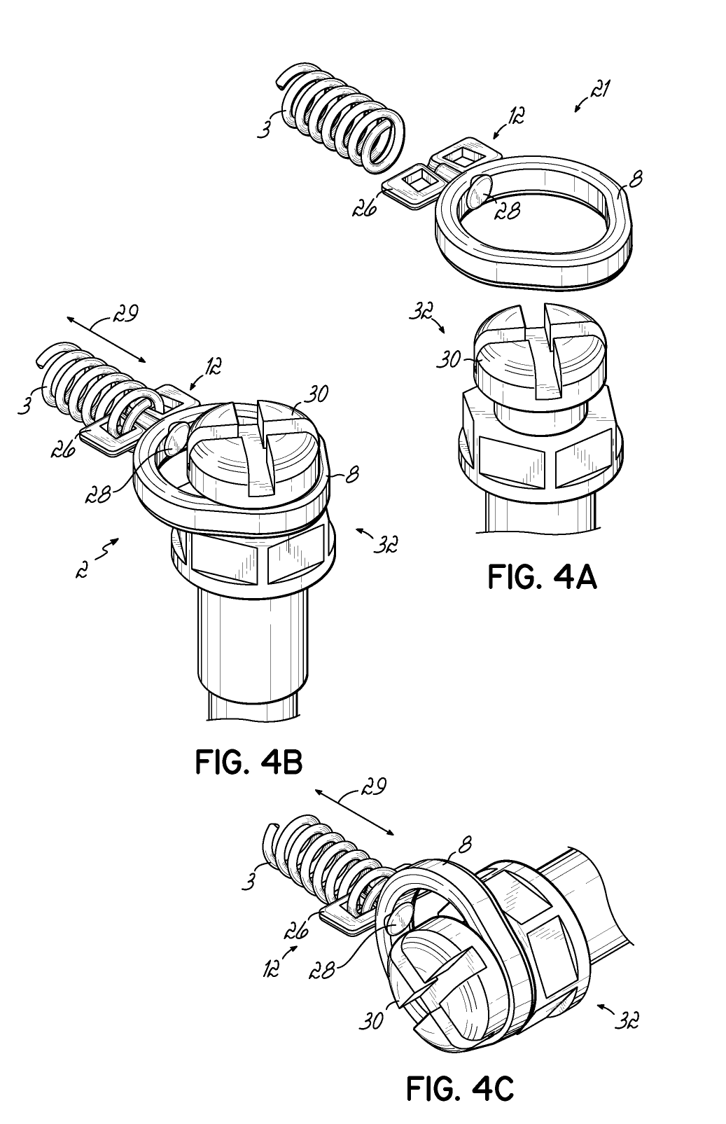

FIGS. 4A, 4B, and 4C depict yet another embodiment of the present invention. Therein an attachment portion 8 (eyelet) is connected to a tension device 3 by a swivel device 12 comprising a clasp 26 for engaging the spring tension device 3. Clasp 26 is connected to attachment portion 8 by a pin 28. While clasp 26 may have any number of structures for receiving the tension device 3, FIG. 4A illustrates the clasp 26 having openings or windows for that purpose. FIG. 4A shows head portion 30 of a temporary implant 32, which receives the attachment portion 8 consistent with the orthodontic treatment.

Swivel device 12 enables attachment portion 8 to have the rotation necessary to engage a temporary implant 32, which may be in one of many multiple locations in the patient's mouth. Two examples of this adaptability are shown in FIGS. 4B and 4C. The examples are especially significant when the auxiliary device 2 extends from a previously attached end (not shown) while the opposing end provides an attachment portion 8 having a swivel device 12 according to the present invention. FIGS. 4B and 4C demonstrate an implant 32 in two different positions, vertically and horizontally oriented, respectively. Yet, in both FIGS. 4B and 4C, the attachment portion 8 is placed over the head 30 of the implant 32 device to complete a vector force by tension device 3. The auxiliary devices 2 of the prior art do not enable this level of adaptation and if the orthodontist is forced to accommodate both locations of the fixture device 32, this would result in the undesired shifting of the patient's teeth.

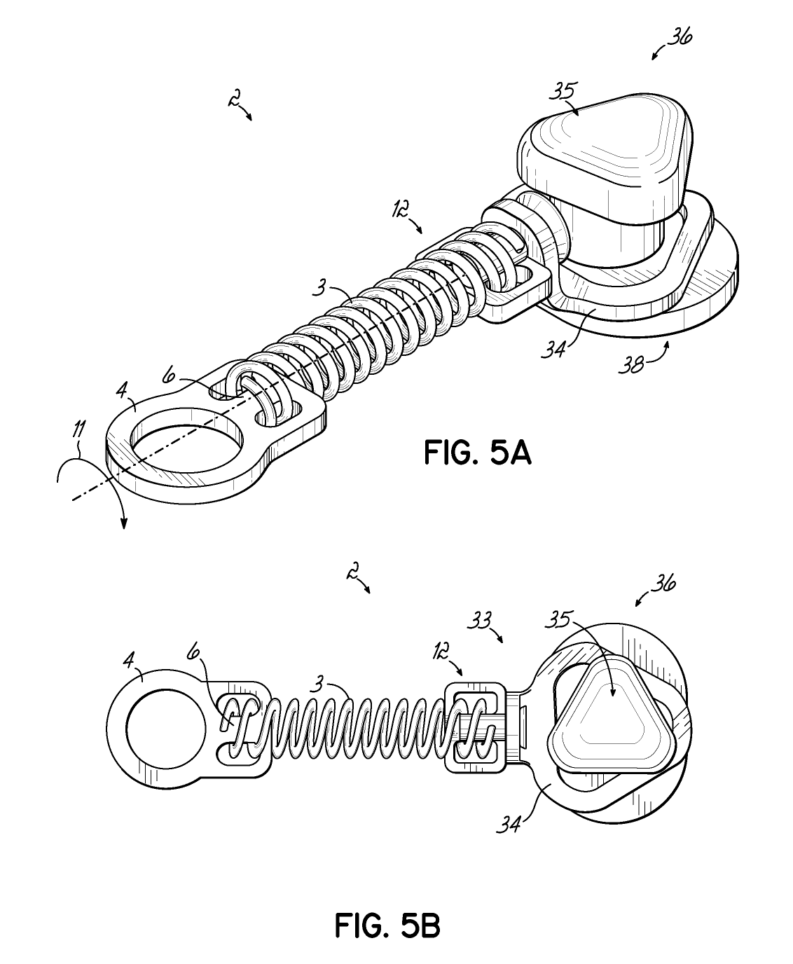

Yet another embodiment is illustrated in FIGS. 5A and 5B. Here a swivel device 12, similar to the embodiment of FIG. 4A, is shown with a locking 33 feature. The lock 33 feature allows the orthodontist to, at least temporarily, secure the position of the auxiliary device 2 by positioning a locking eyelet 34 with respect to a locking bonding button 36. It will be appreciated that in place of bonding button 36, locking eyelet 34 could be secured on the head of an orthodontic implant of the type disclosed in PCT International application No. ______, filed Oct. 10, 2007, and entitled “Orthodontic Implants,” which is expressly incorporated by reference herein in its entirety. Locking 33 includes a swivel device 12, such as those described above or other design, connected to a locking eyelet 34, which is received by a locking bonding pad 36 (or implant, not shown). The locking eyelet 34 may take one of several forms, but for illustrative purposes it is shown as a delta-shaped eyelet. This delta shape cooperates/mates with the structure of the delta-shaped head 35 of locking bonding button 36 (which is described in greater detail below), or the head of an orthodontic implant (not shown). As described previously, swivel device 12 allows for rotation 11 such that the locking eyelet 34 is positioned over and locked with the locking bonding button 36.

The locking bonding button 36 provides an alternative means of attaching orthodontic devices to the patient. Rather than a temporary implant 32, brackets, or an archwire, the locking bonding button 36 provides a surface 38 which is attached, at least temporarily, directly to the surface of a tooth, by an adhesive material known within the art. However, it should be appreciated that the embodiment of the locking feature 33 does not require the use of a locking bonding button 36, but may also include a temporary implant 32 adapted to provide a locking engagement with eyelet 34 by having a delta shape head.

The delta-shaped head 35 of the locking button pad 36 may operate in one of several ways. For example, after receiving the locking eyelet 34, the delta-shaped head 35 is rotated a quarter-turn to secure the position of the locking eyelet 34. Alternatively, the delta-shaped head 35 is stationary—meaning that the locking eyelet 34 must be rotated prior its placement upon the delta-shaped screwhead 35 and then allowed to return to a resting and locked position.

It should be noted that, according to FIGS. 5A and 5B, the opposite end (not shown) of the tension device 3 might possess a hook or eyelet 4 according to the prior art having a fixed attachment point 6 or an attachment portion 8 and a swivel device 12 according to the present invention.

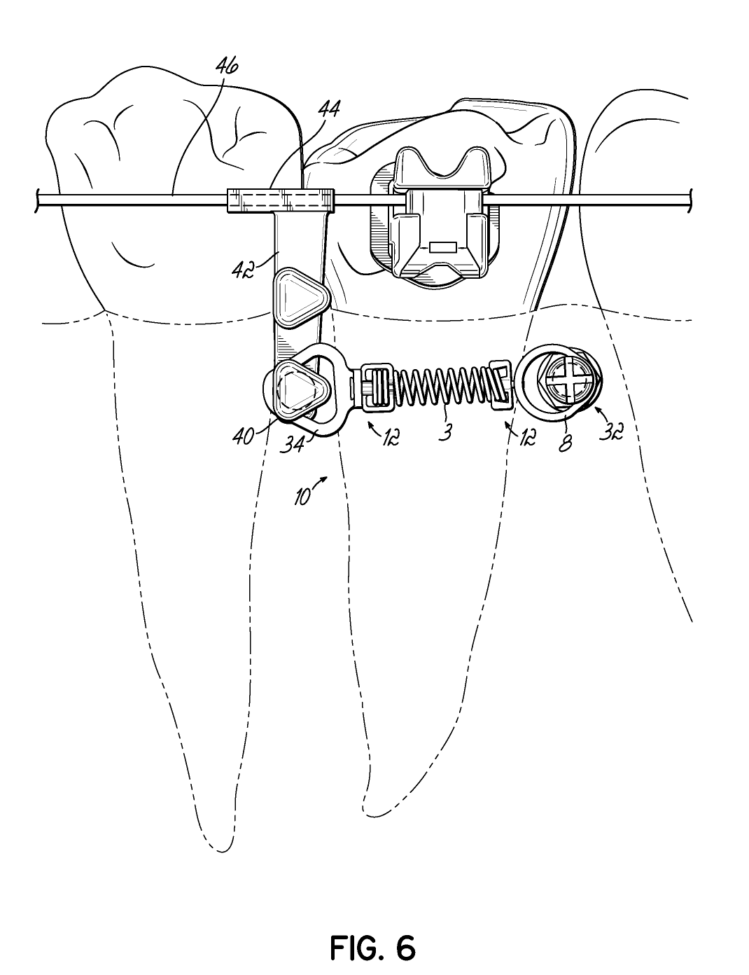

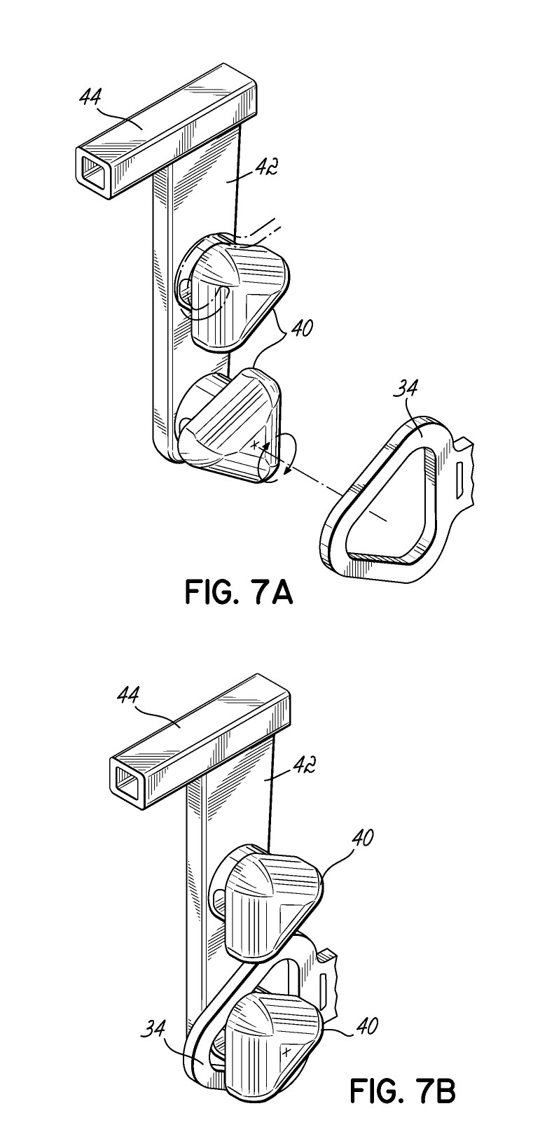

FIGS. 6, 7A and 7B depict additional aspects of the present invention. Specifically, as an alternative to an implant 32 or locking bonding pad 36, FIG. 6 shows locking eyelet 34 engaged or the delta-shaped button 40 or crimpable Post 42. Post 42 has a crimpable portion 44 for engaging an archwire 46 as part of an orthodontic treatment. It will be appreciated that the swivel devices 12 at opposite ends of tension device (spring) 3 allow the auxiliary device 2 to engage an implant 32 and another device, such as crimpable post 42.

With reference to FIGS. 7A and 7B, crimpable post 42 has a crimpable tube portion 44 for engaging an archwire. Post 42 also includes two buttons 40 that are configured (delta-shaped) to receive a delta-shaped locking eyelet 34. It will be appreciated that shapes other than delta-shaped can be advantageously utilized, such as elliptical, for both the button and the eyelet.

The method by which an orthodontist may utilize the present invention is described. After the orthodontist evaluates the patient's teeth for alignment issues, various devices such as archwire, brackets, fixture device (such as a temporary implant or a locking button pad 36) are applied to the teeth and skeletal structure accordingly. An appropriate auxiliary device 2 is selected, having at least one swivel device 12 at one end of the tension device 3. Rotation 11 is applied to swivel device 12 until the attachment portion 8 is oriented such that it is receivable by the temporary implant 32.

A similar process may be repeated for the opposite end of auxiliary device 2. In some circumstances, the orthodontist may find it beneficial to use an auxiliary device 2 having a fixed attachment point 6 on one end of the tension device 3 and a swivel device 12 at the other end. In such cases, the orthodontist would initially attach the fixed attachment point 6 prior to attaching the opposing end. The opposing end of the auxiliary device 2 would then be directed toward the appropriate temporary implant 32. Rotation 11 of the attachment portion 8 then allows for the proper alignment of the attachment portion 8 with the temporary implant 32 while maintaining the desired vector forces 29 upon the teeth.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. An orthodontic auxiliary device comprising:
a tension device;
an attachment portion removeably attachable to a fixture device; and
a swivel device connecting the attachment portion to the tension device, wherein the swivel device allows at least a partial rotation of the attachment portion about a central axis of the tension device.

2. An orthodontic auxiliary device as in claim 1 wherein the swivel device is comprised of a ball-and-socket joint.

3. An orthodontic auxiliary device as in claim 1 wherein the swivel device is a pin connecting the attachment portion to the tension device.

4. An orthodontic auxiliary device as in claim 1 wherein the attachment portion is an eyelet.

5. An orthodontic auxiliary device as in claim 5 wherein the eyelet further comprises a clasp for receiving the tension device.

6. An orthodontic auxiliary device as in claim 1 wherein the attachment portion is a hook.

7. An orthodontic auxiliary device as in claim 1 wherein the tension device is a spring.

8. An orthodontic auxiliary device as in claim 1 wherein the fixture device is an orthodontic implant.

9. An orthodontic auxiliary device as in claim 7 wherein the swivel device includes a rim that fits interstitially between coils of the spring.

10. An orthodontic auxiliary device as in claim 1 wherein the fixture device is a bonding button.

11. An orthodontic auxiliary device as in claim 1 wherein the fixture device is a crumpable post.

12. An orthodontic auxiliary device comprising:
a tension device;
an attachment portion having a lock-shape that is removably attachable to a fixture device, wherein the fixture device has a lock-shape portion adapted to receive the lock-shape attachment portion, wherein one of either the attachment portion or the lock-shape portion is moveable in a manner to secure the position of the attachment portion to the fixture device; and
a swivel device connecting the attachment portion to the tension device and wherein the swivel device allows at least partial rotation of the attachment portion about a central axis of the tension device.

13. An orthodontic auxiliary device as in claim 9 wherein the lock-shape is a delta.
